(19) United States
(12) Patent Application Publication
(10) Pub. No.: US 2009/0145703 A1
(43) Pub. Date: Jun. 11, 2009

(54) PROCESS FOR PRODUCTION OF A BRAKE LINING AND BRAKE LINING IN PARTICULAR FOR A MOTOR-VEHICLE DISK BRAKE

(75) Inventor: Andreas Elvenkemper, Leverkusen (DE)

Correspondence Address: CONNOLLY BOVE LODGE & HUTZ, LLP, P O BOX 2207, WILMINGTON, DE, 19899, US

(73) Assignee: TMD Friction Services GmbH

(21) Appl. No.: 12/302,930

(22) PCT Filed: May 7, 2007
(86) PCT No.: PCT/EP07/03992

§ 371 Date: Dec. 1, 2008

(30) Foreign Application Priority Data
Jun. 7, 2006 (DE) 10 2006 026 802.4

(51) Int. Cl. F16D 65/04; B29C 43/28

(52) U.S. Cl. 188/250 E; 264/319

(57) ABSTRACT

A friction lining (4) of a brake is made of a friction material (41) and has a grid (1) that is made of an elastic filling material embedded into the friction material. As a first step, the grid (1) made of the filling material is placed into a friction-lining compression mold in such a way that one grid side ends with a friction surface. Essentially pulverulent friction material is then filled into the compression mold and press-molded with the grid (1) in such a manner that the interstices in the grid and between the compression mold and the grid are filled up with friction material, forming a flush friction surface. During the press-molding procedure, the filling material grid (1) is subjected to high pressing forces in the tangential as well as radial directions.

### CROSS-REFERENCE TO RELATED APPLICATION

This application is a national stage application (under 35 U.S.C. § 371) of PCT/EP2007/003992, filed May 7, 2007, which claims benefit of German application 10 2006 026 802.4, filed Jun. 7, 2006.

### DESCRIPTION

The invention relates to a method for the production of a brake lining having a friction lining made of a friction material and having a grid that is made of an elastic filling material embedded into the friction material. Moreover, the invention relates to a brake lining, particularly for a motor vehicle disk brake.

### BACKGROUND ART

It is a known procedure to create grooves having a certain pattern in friction linings made of a friction material, the depth of said grooves extending all the way down to a vibration-damping interlayer. This groove serves to diminish the stiffness of the lining so as to reduce the moment fluctuations that occur during braking.

German patent application DE 100 41 294 A1 discloses the approach of filling the grooves with an elastic filling material that does not consist of friction material. The elastic filling material raises the coherence and the strength of the friction lining that is weakened by the grooves. The reduced stiffness of the lining allows a better adaptation to irregularities on a brake disk since the friction lining can become deformed by the elastic filling material that fills the grooves. This prevents juddering noises and vibrations caused by the reduction in the moment fluctuations. Pulsating of the pedal, as well as the noises that occur during the braking procedure, are dampened.

A similar method is disclosed in German patent application DE 100 41 308 B4, in which the friction lining provided with the grooves is subjected to a scorching process, after which the elastic filling material is filled into the groove. Subsequently, the friction pad consisting of the friction lining and the filler is subjected to a drying, curing or cross-linking process.

### SUMMARY OF THE INVENTION

The invention is based on the objective of improving the durability of the brake lining while minimizing moment fluctuations, and of putting forward a particularly simple method for the production of the brake lining.

The method according to the invention for achieving this objective is characterized in that first of all, the grid is made of the filling material and placed into a friction-lining compression mold in such a way that one grid side ends with a friction surface, and in that essentially pulverulent friction material is then filled into the compression mold and press-molded with the grid in such a manner that the interstices in the grid and between the compression mold and the grid are filled up with friction material, forming a flush friction surface, whereby the filling material grid is subjected to high pressing forces in the tangential as well as radial directions.

The grid structure of the filling material can be optimally shaped in a shaping procedure of its own, so that the suitable thickness and precise delineations can be prescribed for the envisaged grid pattern. The coherence between the filling material and the friction material is improved and made more uniform by the tangential and radial pressing forces that act upon the filling material grid. When the friction lining consisting of the friction material with the embedded elastic filling material is press-molded, relatively large surface areas of the material volumes are subjected to the pressing forces. Even complex grid structures can be shaped without any problem and the entire structure of the press-molded lining can be improved. The uniform press-molding procedure minimizes the need for final finishing work.

In the brake lining according to the invention, the friction lining has a press-molded part made of a prefabricated filling material grid and of friction material that is press-molded at least laterally together with the grid webs, whereby the grid webs and the friction material press-molded with them form a flush friction surface. The friction material and the filling material grid are press-molded into a dimensionally stable unit and thus exhibit high durability and stability. The embedded grid consisting of elastic filling material ensures an outstanding adaptation of the friction lining to irregularities on a brake disk, minimizes juddering noises and vibrations as well as secondary effects due to pedal pulsations and steering wheel vibrations. The shape, matrix and structure of the filling material grid can all be adapted to the configuration of the friction lining in such a way that optimal functional properties are ensured for the entire friction lining.

In an advantageous embodiment of the method according to the invention, it is provided that the filling material grid is produced by press-molding the filling material into a compression mold adapted to the prescribed friction material thickness, followed by pre-curing. The subsequent press-molding of the friction material with the filling material grid ensures an optimal bond of all of the components of the friction lining.

The friction material can be press-molded with the filling material grid over a vibration-damping interlayer. In this process, the filling material grid, the friction material and the interlayer are joined to create a unit that makes up the friction lining.

The filling material can consist primarily of rubber or rubber substitutes, optionally with the addition of abrasive materials and/or grinding media. In principle, any conventional filling material compositions can be employed that can be shaped as filling material grids with elastic properties.

Refinements of the invention are characterized in the subordinate claims.

### BRIEF DESCRIPTION OF THE DRAWINGS

The invention will be explained in greater detail below, making reference to an embodiment depicted in the drawings. The drawings show the following:

FIG. 1—a view of an embodiment of a filling material grid after its production by press-molding the filling material in grid form and pre-curing of the press-molded filling material grid;

FIG. 2—a perspective view of a friction-lining compression mold into which the pre-fabricated filling material grid is placed with the friction surface facing down-wards before the remaining mold cavity is filled with the friction material; and

FIG. 3—a view onto a finished brake lining for a motor vehicle disk brake, having a support plate and a friction lining on whose visible friction surface the pre-fabricated filling material grid is aligned flush in a plane with the surrounding friction material.

### DETAILED DESCRIPTION OF THE INVENTION

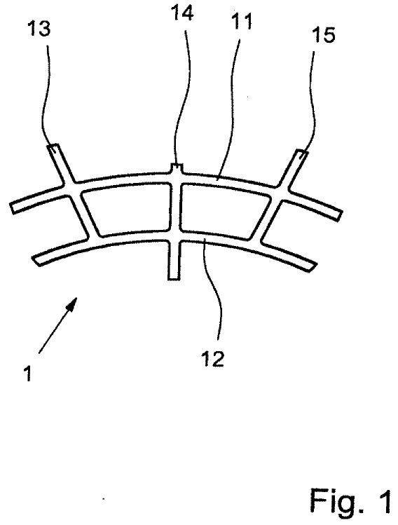

In the described embodiment, the prefabricated filling material grid 1 shown in FIG. 1 has two essentially concentric, semicircular webs 11 and 12 that run approximately in the feed direction. The curved webs 11 and 12 of the grid 1 are joined to each other via webs 13, 14 and 15 that run approximately radially. On both sides, the curved webs 11 and 12 have ends that protrude beyond the outer radial web and whose front surfaces are adapted to the radial inner walls of the compression mold. The outer radial webs 13 and 15 each have an end section protruding towards the outside; the center radial web 14 has two end sections that protrude beyond the adjacent curved webs 11 and 12. All of the protruding end sections of the radial webs 13 to 15 are adapted to the inner walls of the compression mold, so that the prefabricated grid structure 1 of the front surfaces of each of the protruding web ends suitably lies against the inner contour of the compression mold in the area close to the friction surface.

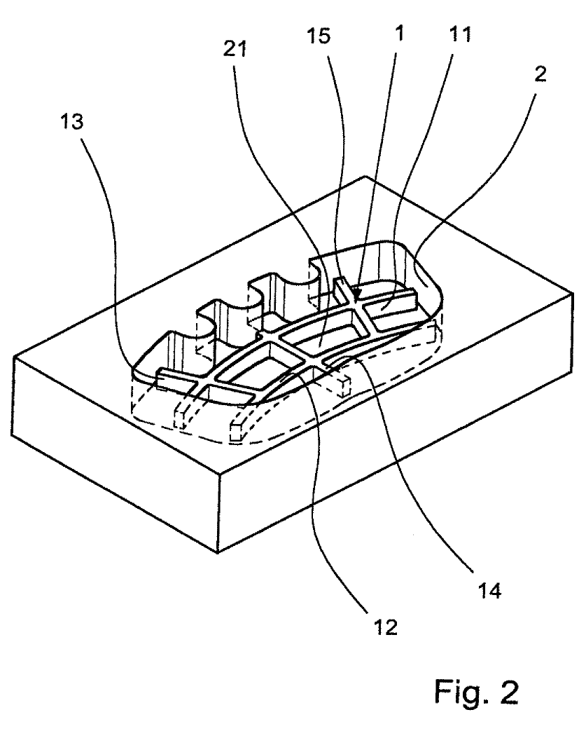

As shown in FIG. 2, the prefabricated grid 1 is placed into the compression mold 2 in such a manner that a flat side of the grid 1 lies on the mold surface 21 that forms the friction plane. In this context, as mentioned above, the position of the grid 1 is determined by the suitably shaped front surfaces of the webs 11 to 15 which are aligned with each of the opposite inner walls of the mold.

Once the prefabricated filling material grid has been laid into the compression mold 2, the mold cavity is filled with a suitable friction material, a process in which the filling material grid is coved with friction material. Subsequently, the friction material—optionally after adding a vibration-damping interlayer on the side opposite from the friction surface—is press-molded in such a way that the friction material fills the prefabricated filling material grid 1 in all of the interstices between the grid webs 11 to 15 as well as in the interstices adjacent to the mold walls. In this manner, the filling material grid is completely surrounded by the friction material in the tangential and radial directions under high pressing forces, and the friction surface is shaped precisely in the mold plane. This creates a tight bond and accounts for a high level of stability of the components that make up the friction lining.

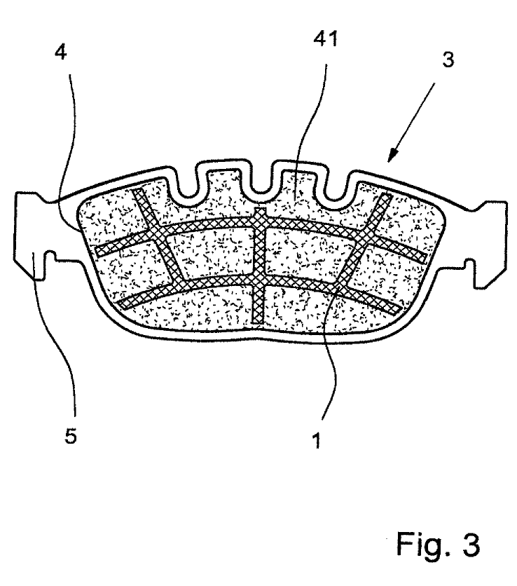

FIG. 3 shows the finished brake lining 3 after it has been removed from the mold and after the friction lining 4 has been glued to a support plate 5, which is arranged on the side of the friction lining 4 facing away from the friction surface, optionally with the addition of a vibration-damping interlayer. As can be seen in FIG. 3, the finished brake lining has a friction surface on the friction side that is made of friction material 41 that is interrupted by the prefabricated filling material grid 1 in a grid-like pattern. Each of the flat sides consisting of friction material 41 and filling material extends flush in a plane on the friction surface side, whereby the delineations of the filling material and if the friction material are closely and smoothly in contact with each other on all sides.

The described friction lining ensures a sturdy bond between adjacent material structures and thus optimal durability and a reduction of the moment fluctuations that occur during the braking operation due to the elastic properties of the filling material grid 1.

The height of the covering of the filling material grid with friction material can be freely selected as a function of the requirements in question. The same applies to the thickness, number and layout of the grid webs. Diverging from the embodiment described above, if necessary, the friction surface can also be curved and/or interrupted. As a rule, the filling material grid will be adapted to the compression mold; the same holds true of the friction surfaces of the finished friction lining and of the side of the filling material grid facing the friction surface.

While preferred embodiments of the invention have been described and illustrated here, various changes, substitutions and modifications to the described embodiments will become apparent to those of ordinary skill in the art without thereby departing from the scope and spirit of the invention.

1-12. (canceled)

13. A method for making a brake lining having a friction lining, comprising:
placing a grid (1) made of an elastic filling material embedded into a friction material into a friction-lining compression mold (2) in such a way that one grid side ends with a friction surface;
filling the compression mold with essentially pulverulent friction material (41); and
press-molding the pulverulent friction material with the grid in the compression mold in such a manner that the interstices in the grid and between the compression mold and the grid are filled up with friction material to form a flush friction surface, wherein the grid is subjected to pressing forces in both tangential and radial directions.

14. The method according to claim 13, wherein the grid (1) is produced by press-molding the filling material into a compression mold (2) adapted to the prescribed friction material thickness, followed by pre-curing.

15. The method according to claim 13, wherein the friction material (41) is press-molded with the grid (1) over a vibration-damping interlayer.

16. The method according to claim 13, wherein the filling material comprises primarily rubber or rubber substitutes.

17. The method according to claim 13, wherein the filling material contains abrasive materials and/or grinding media.

18. The method according to claim 13, wherein the filling material contains organic and/or inorganic fibers.

19. A brake lining, particularly for a motor vehicle disk brake, comprising:
a friction lining (4) made of a friction material (41) and having a grid (1) that is made of an elastic filling material embedded into the friction material and defining one or more grid webs (11-15), wherein the friction lining (4) comprises a press-molded part made of a prefabricated grid (1) defining one or more grid webs (11-15) and of friction material (41) that is press-molded at least laterally together with the grid webs (11-15), whereby the grid webs and the friction material press-molded with them form a flush friction surface.

20. The brake lining according to claim 19, wherein the thickness of the friction material is adapted to the thickness of the grid webs (11-15).

21. The brake lining according to claim 19, wherein the friction material (41) is covered on a side facing away from the friction surface with a vibration-damping interlayer which is followed by a support plate (5).

22. The brake lining according to claim 19, wherein the filling material comprises primarily rubber or rubber substitutes.

23. The brake lining according to claim 19, wherein the filling material contains abrasive materials and/or grinding media.

24. The brake lining according to claim 19, wherein the filling material contains organic and/or inorganic fibers.
